(19) United States
(12) Patent Application Publication
(10) Pub. No.: US 2007/0229410 A1
(43) Pub. Date: Oct. 4, 2007

(54) DISPLAY APPARATUS

(75) Inventors: Takanori YAMASHITA, Yokohama-shi (JP); Masami Iseki, Yokohama-shi (JP); Somei Kawasaki, Saitama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/687,881

(22) Filed: Mar. 19, 2007

(30) Foreign Application Priority Data
Mar. 31, 2006 (JP) 2006-097997

(51) Int. Cl. G09G 3/30

(52) U.S. Cl. 345/76

(57) ABSTRACT

A display apparatus includes a color display unit including pixels arranged in a matrix. The pixels includes first pixels for blue, second pixels for green, and third pixels for red, data lines connected to corresponding columns in the color display unit, and column-driving circuits connected to the columns in the color display unit and configured to convert input video-signal voltages into color-data-signal currents to be supplied to the color pixels and output the currents to the data lines. Voltage-current conversion gains of the column-driving circuits supplying color-data-signal currents to the first color pixels are set larger than those of the column-driving circuits supplying color-data-signal currents to the second and third color pixels, each of which has a luminance efficiency relative to a current higher than those of the first color pixels.

### BACKGROUND OF THE INVENTION

1. Field of the Invention

The present invention relates to a color display apparatus in which a plurality of colors of pixels are arranged in a matrix.

2. Description of the Related Art

In recent years, a display apparatus utilizing electro-optical devices has come to the front as a next generation display apparatus. As an example of such a device, an organic electroluminescence (EL) device which is a light-emitting device of current control type for controlling luminance by means of current flowing through the device will be described. An organic EL display including peripheral circuits uses thin-film transistors (TFTs) in the peripheral circuits in addition to a display area thereof. An image display panel in which such EL devices, which are self-emitting devices, are used as image display devices and TFTs are used in the display area and the peripheral circuits will be described hereinafter with reference to the accompanying drawings.

An EL panel 100 shown in FIG. 18 includes a display unit 9 in which a plurality of EL devices corresponding to the number of RGB primary colors and pixels (pixel circuits) 2 having TFTs for controlling currents supplied to the EL devices are arranged in a matrix of N columns and M rows. The EL panel 100 further includes peripheral circuits. Of the peripheral circuits, an input circuit 6 receives horizontal scanning control signals 11a externally supplied, an input circuit 7 receives vertical scanning control signals 12a externally supplied, and an input circuit 8 receives auxiliary-column-control signals 13a externally supplied.

The horizontal scanning control signals 11a are converted into horizontal scanning control signals 11 (serving as horizontal clock signals and horizontal scanning start signals) in the input circuit 6 and input to column-shift registers 3. The vertical scanning control signals 12a are converted into vertical scanning control signals 12 in the input circuit 7 and input to row-shift registers 5. Row-scanning signals 20 are output from output terminals of the row-shift registers 5 and are input to the corresponding pixel circuits 2 in every row through scanning lines.

The auxiliary-column-control signals 13a are converted into the auxiliary-column-control signals 13 in the input circuit 8 and the auxiliary-column-control signals 13 are supplied to gate circuits 4 and 16. Horizontal sampling signals 17 are output from terminals of column-shift registers 3 and are supplied to corresponding horizontal sampling signal gate circuits 15 together with control signals 21 which are converted from the auxiliary-column-control signals 13 in the gate circuit 16. The horizontal sampling signals 17 are converted into horizontal sampling signals 18 in the horizontal sampling signal gate circuits 15. The horizontal sampling signals 18 are supplied to column-driving circuits 1 together with video signals (voltage signals) 10 externally supplied and control signals 19 converted from the auxiliary-column-control signals 13 in the gate circuit 4. The video signals 10 are converted into column-control signals 14, which are current signals, in the column-driving circuits 1, and the column-control signals 14 are supplied to the pixel circuits 2 in corresponding columns through data lines.

The column-driving circuits 1 corresponding to the number of primary colors (for example, three colors, i.e., red, green, and blue) of the pixel circuits 2 in each column, that is, corresponding to the number of input video signals 10 having the primary colors are arranged. The column-driving circuits 1 employ a voltage-current conversion circuit that converts video-signal voltages which are input in time series and dot-sequentially, that is, on a dot-by-dot basis into video-signal currents which are output line-sequentially, and therefore are output simultaneously on a row-by-row basis.

FIG. 19 shows an example of a configuration of a voltage-current conversion circuit employed in the column-driving circuits 1.

In FIG. 19, gm denotes a voltage-current conversion circuit, M0 to M3 denote p-channel TFTs, and M4 to M6 denote n-channel TFTs. Furthermore, V(data) denotes a video-signal voltage input to the voltage-current conversion circuit gm, I(data) denotes a current signal (a data signal) output from the voltage-current conversion circuits gm to data lines. Moreover, VCC denotes a power supply, V0 denotes a reference current bias value, Vref denotes a reference voltage, and P0 denotes a control signal. Here, the TFTs M2 and M3 form a source-coupled circuit and the TFTs M4 and M5 form a current mirror circuit.

In the voltage-current conversion circuit gm shown in FIG. 19, the video-signal voltage V(data) is input to a gate G of the TFT(M2). Then, the current signal I(data) having a current value corresponding to a voltage value of the video-signal voltage V(data) is generated and the current signal I(data) is output to the data lines through the source coupling circuit and the current mirror circuit.

In this voltage-current conversion circuit gm, when the correlations between the TFT M0 and the TFT M1, between the TFT M2 and the TFT M3, and between the TFT M4 and the TFT M5 are recognized, a voltage-current conversion gain depends on a drain current of the TFT M1 and driving capabilities of the TFT M2 and the TFT M3. Note that other circuit configurations and other methods for driving the column-driving circuit are disclosed in the specification of U.S. Pat. No. 7,126,565 and FIGS. 1 and 2 thereof.

However, each of the above-described TFTs has an active layer including a non-single-crystal semiconductor. Accordingly, when compared with a transistor having an active layer including a single-crystal semiconductor, variation among devices is significant due to the characteristics of the non-single-crystal semiconductor and the correlation of the variation between proximal devices is not assured. Since threshold values and carrier mobilities of the TFTs are varied, voltage-current conversion gains in the column-driving circuits are varied among the EL devices. Accordingly, current values supplied to the EL devices are also varied among the pixels. Consequently, the EL devices fail to emit light at a desired luminance resulting in variation of luminance of a display area.

U.S. Patent Application Publication No. 2004-0183752 discloses a circuit configuration for suppressing variation of luminance. In this circuit configuration, output currents from column-driving circuits which drive pixel circuits are detected, each of the output currents is compared with reference current data, calculation to obtain a correction coefficient is performed, and a video signal input to the column-driving circuit is corrected using the correction coefficient whereby the variation of luminance is suppressed.

However, in the method for correcting video signals by detecting output currents of the column-driving circuits as described in U.S. Patent Application Publication No. 2004-0183752, when pixel density is increased and outputs from the column-driving circuit are reduced, a detection signal having a sufficient S/N ratio may not be obtained. Furthermore, as the number of column-driving circuits is increased, time necessary for detection and time necessary for correcting processing are not negligible.

Regarding luminescence materials for primary colors, such as red (R), green (G), and blue (B), included in color pixels of an EL panel, luminescence materials having a sufficient luminance relative to supplied current (luminance efficiency) are not easily used for a B pixel compared with an R pixel or a G pixel.

The B pixel requires a considerable amount of current to obtain a luminance the same as that of the R pixel or that of the G pixel in the EL panel. As a method for obtaining such luminance, it is considered that the amplitude of a video-signal voltage for the B pixel is set larger so that a large amount of output current is obtained.

However, a low-voltage power supply is required for an external controller IC (integrated circuit), which defines the voltage amplitude of a video signal input to the EL panel, to reduce the cost and the power consumption thereof. Accordingly, it is difficult to set the amplitude of the video-signal voltage to be larger.

FIG. 20 is a diagram showing the relationship between an output current Id and an input video-signal voltage Vgs of a voltage-current conversion transistor included in a column-driving circuit. Here, it is assumed that input video signals (Video(R), Video(G), and Video(B)) have voltage amplitudes VR, VG, and VB, respectively, which are different among the color component RGB. In this case, operation areas based on input voltage-output current characteristics (Vgs-Id characteristics) of the voltage-current conversion transistor, which is used for outputting currents to corresponding columns of RGB color components, are varied. Therefore, the voltage-current conversion characteristics for different luminance levels varying from a lowest level to a highest level, are varied for each of the color components R, G, and B, resulting in difficult control of a white balance in each gradation level. Accordingly, a gamma characteristic should be uniquely set for each of the color components R, G, and B.

As a result, a method for supplying video signals which have modulation ranges of voltage amplitudes for different colors, that is, which have maximum voltage amplitudes which are different among colors, is not preferable for providing an inexpensive apparatus. This drawback is not unique to EL panels; electro-optical devices using electron-emitting devices and phosphors in combination have the same drawbacks.

### SUMMARY OF THE INVENTION

The invention provides inexpensive display apparatuses and inexpensive active matrix apparatuses which contribute to reduction of voltage required for an external controller IC and control of a white balance.

The invention provides display apparatuses and active matrix apparatuses in which voltage amplitudes for input video signals do not have to be set significantly different from one another in accordance with colors of input video signals and gamma characteristics, which are used for correction of difference between areas for individual colors in which the voltage-current conversion characteristics of the column-driving circuits are changed, are not necessary to be uniquely set for each color.

A display apparatus according to an aspect of the invention includes a color display unit including pixels arranged in a matrix, the pixels including first pixels each of which emits first light in accordance with a current, and second pixels each of which emits second light, which is different from the first light, in accordance with a current; row selection lines provided for rows in the matrix of the pixels in the color display unit; data lines provided for columns in the matrix of the pixels in the color display unit, pixels in each of the columns being used for displaying the same color; and column-driving circuits configured to convert input video-signal voltages into data-signal currents and to output the data-signal currents to the data lines, the column-driving circuit being provided for corresponding data lines. An efficiency of luminance of each of the first pixels relative to a current is lower than that of each of the second pixels relative to a current. Voltage-current conversion gains of the column-driving circuits which supply data-signal currents to corresponding data lines used for the first pixels are set larger than those of the column-driving circuits which supply data-signal currents to corresponding data lines used for the second pixels.

Since the voltage amplitudes for input video signals do not have to be set significantly different from one another in accordance with colors of the input video signals, the invention contributes to reduction of voltages required for an external controller IC and provides inexpensive display apparatuses and inexpensive active matrix apparatuses. Furthermore, since gamma characteristics, which are used for correction of difference between areas in which the voltage-current conversion characteristics of the column-driving circuits are changed, are not necessary to be uniquely set for each color, a white balance can be easily controlled and inexpensive display apparatuses and inexpensive active matrix apparatuses can be provided.

Moreover, a correction circuit may be omitted. Even when a correction circuit is used, time required for correction processing may be reduced. That is, since correction processing may be performed without a high-speed correction circuit, an inexpensive correction circuit can be achieved.

The display apparatus can include a correction circuit configured to detect outputs of the column-driving circuits and to correct video-signal voltages supplied, in accordance with results of the detection, to the column-driving circuits divided into blocks on a block-by-block basis. Accordingly, nonuniform display of images, such as stripes having a wide pitch therebetween shown in a display screen, may be suppressed.

The display apparatus can include first color pixels having light emitting devices each of which emits blue light and second color pixels having light emitting devices each of which emits red light or green light. Since, in general, a light emitting device, such as an organic EL device, has a low luminance efficiency for blue light, when voltage-current conversion gains of column-driving circuits for the color blue are comparatively set larger than those of column-driving circuits for other colors, degree of freedom for selection of materials and configurations of light emitting devices for the color blue is increased.

The display apparatus can include a selection circuit used for selecting data lines to which outputs of the column-driving circuits are supplied and a control circuit used for controlling the selection circuit so that the data lines to which outputs of the column-driving circuits are supplied are sequentially changed for individual scanning periods. By this, variation of values of currents supplied to pixels or pixel circuits may be temporally averaged, that is, may be spatially distributed. Accordingly, nonuniform display of images, such as stripes having a wide pitch therebetween shown in a display screen, may be suppressed.

According to the display apparatus, certain rows can be selected by an interlace scanning method so that pixels located in adjacent two rows connected to a common data line do not receive outputs from the same column-driving circuit in one frame scanning period. Accordingly, variation of values of currents supplied to pixels or pixel circuits in the adjacent two rows in a frame may be spatially distributed. Furthermore, nonuniform display of images, such as stripes having a wide pitch therebetween shown in a display screen, may be suppressed.

Further features of the present invention will become apparent from the following description of exemplary embodiments with reference to the attached drawings.

### BRIEF DESCRIPTION OF THE DRAWINGS

FIG. 1 is a block diagram illustrating a configuration of a display apparatus according to a first embodiment of the present invention.

FIG. 2 is a circuit diagram illustrating a signal detection circuit employed in the invention.

FIG. 3 is a circuit diagram illustrating a pixel circuit employed in the invention.

FIG. 4 is a timing chart illustrating an operation of the pixel circuit shown in FIG. 3.

FIG. 5 is a circuit diagram illustrating a voltage-current conversion circuit employed in the invention.

FIGS. 6A and 6B are schematic top plan views illustrating a voltage-current conversion transistor employed in the invention.

FIG. 7 is a block diagram illustrating a correction circuit employed in the invention.

FIG. 8 is a circuit diagram illustrating a selection circuit according to the invention and the vicinity thereof.

FIG. 9 is a timing chart illustrating a sampling operation of a column-driving circuit employed in the invention.

FIG. 10 is a timing chart illustrating a programming operation according to the first embodiment of the invention.

FIG. 11 is a schematic view illustrating a programming operation according to the first embodiment of the invention.

FIG. 12 is a timing chart illustrating a programming operation according to a second embodiment of the invention.

FIG. 13 is a timing chart illustrating a programming operation according to the second embodiment of the invention.

FIG. 14 is a schematic diagram illustrating a programming operation according to the second embodiment of the invention.

FIG. 15 is a block diagram illustrating a column-driving circuit and circuits in the vicinity thereof according to a third embodiment of the invention.

FIG. 16 is a schematic diagram illustrating the relationship between a characteristic of the voltage-current conversion transistor and an amplitude of a video signal according to the first embodiment of the invention.

FIG. 17 is a block diagram illustrating an example of electronic apparatuses to which the invention is applied.

FIG. 18 is a block diagram illustrating a display apparatus in the related art.

FIG. 19 is a circuit diagram illustrating an example of a column-driving circuit.

FIG. 20 is a schematic diagram illustrating the relationship between a characteristic of the voltage-current conversion transistor and an amplitude of a video signal.

### DESCRIPTION OF THE EMBODIMENTS

Best modes for embodying a display apparatus or an active matrix apparatus according to the invention will be described hereinafter in detail with reference to the accompanying drawings.

Electro-optical devices employed in the invention include organic EL devices, inorganic EL devices, light-emitting devices using electron-emitting devices and phosphors in combination, and light-emitting diodes.

Pixels include color pixels having a plurality of different colors. The color pixels as electro-optical devices may be used in a passive matrix circuit or the color pixels (pixel circuits) may be used in an active matrix circuit having at least one transistor. The color pixels include color pixels to be displayed as three primary colors for light, i.e., red, blue, and green, or color pixels to be displayed as three colors, i.e., yellow, cyan, and magenta. The luminous efficiency of each of the color pixels with respect to a current depends on a material used for a corresponding one of the electro-optical devices included in the color pixel. Accordingly, when the color pixels include three colors, one of the three colors in the color pixels may have a luminous efficiency lower than that of each of the other colors in the color pixels. Similarly, when the color pixels include three colors, two of the three colors in the color pixels may have the same luminous efficiency which is lower than that of the other color in the color pixels.

A column-driving circuit employed in the invention includes a voltage-current conversion circuit for converting a video-signal voltage into a data-signal current.

In addition, the column-driving circuit is used for supplying a data signal to an electro-optical device included in a passive matrix circuit or used for supplying a data signal to a pixel circuit included in an active matrix circuit.

One or two voltage-current conversion circuits may be arranged in each of the column-driving circuits and the two voltage-current conversion circuits may be switched for each horizontal scanning period.

The invention is effectively used for voltage-current conversion circuits in which characteristic variations of transistors included in the column-driving circuits are likely to be generated due to fabrication processing thereof. Accordingly, the invention is suitably applied to column-driving circuits including TFTs which employ non-single-crystal semiconductors as active layers. The non-single-crystal semiconductors include non-crystal silicones, polycrystalline silicones, and microcrystalline silicones and transistors employing single-crystal semiconductors, such as monocrystalline silicones, as active layers may be used.

In the invention, color pixels and pixel circuits are arranged in a matrix and data signals of the invention are simultaneously supplied to color pixels or pixel circuits, which are selected by a common row-selection line, in the same row on a row-by-row basis. A period during which all rows are selected one by one corresponds to the horizontal scanning period. After all the rows are sequentially selected, output of the data signals in a frame scanning period is completed.

In the invention, in a case where a data line to be used for receiving an output from the corresponding one of the column-driving circuits is changed for each scanning period, it is desirable to change the data line for each horizontal scanning period or for each vertical scanning period, such as a field scanning period or a frame scanning period. In other words, a scanning period includes a horizontal scanning period, a period during which a plurality of number of times a horizontal scanning is performed, a field scanning period, or a frame scanning period.

Specifically, three column-driving circuits to which R signals are input, three column-driving circuits to which G signals are input, three column-driving circuits to which B signals are input are arranged, and three columns of R pixels, three columns of G pixels, and three columns of B pixels are arranged so as to correspond to the column-driving circuits to which R signals are input, the column-driving circuits to which G signals are input, and the column-driving circuits to which B signals are input, respectively. The columns of these three colors are arranged along row selection lines in an order of R, G, and B.

Each of the voltage-current conversion transistors in the column-driving circuits has a channel length and a channel width set in accordance with the luminance efficiency of the RGB color components. The channel length is also called “gate length” which is the distance between a source and a drain in a direction in which a current is supplied in a field effect transistor (FET). The channel width is called “gate width” which is a length extending in a direction perpendicular to a direction in which a current is supplied in the FET.

The column-driving circuits supply data-signal currents to nine columns in total. Focusing on a single color signal, in a constant cycle, such as in every scanning period, a pair of one of blocks of three column-driving circuits and one of blocks of three data lines of three corresponding columns to which signals are supplied from the column-driving circuits is sequentially changed.

The present invention is employed for a matrix color display apparatus using electro-optical devices, and furthermore, is suitably employed for an active matrix display apparatus which does not include electro-optical devices such as EL devices.

Specifically, the display apparatus according to this embodiment includes a color display unit (an active matrix unit) in which color pixel circuits including electro-optical devices serving as color pixels and transistors are arranged in a matrix. Furthermore, the display apparatus includes column-driving circuits which output data signals to data lines and row selection circuits (scanning circuits) which outputs row selection signals (scanning signals) to row selection lines (scanning lines). Moreover, the display apparatus includes terminals which are used to input video signals and control signals and used to supply power sources and common lines connected to electro-optical devices provided for pixels. The common lines are arranged so as to surround a display area and have line drawing portions connected to some of the terminals through lines.

In the invention, a correction circuit may be provided. In the correction circuit, output currents are detected as needed for each of the blocks of a plurality of column-driving circuits, and in accordance with the detection, video signals are corrected and supplied to the blocks of a plurality of column-driving circuits. For example, currents output from three column-driving circuits all of which correspond to the same color are added to detect an added value, and in accordance with the detected value (an evaluation value), video-signal voltages to be supplied to the column-driving circuits all of which correspond to the same color are corrected. Accordingly, variation among the three column-driving circuits may be suppressed.

According to the invention, in a case where a configuration in which destinations of currents output from column-driving circuits are changed for each scanning period is employed, video signals supplied to the column-driving circuits are subjected to sampling processing taking the change of the output destination into consideration, or an order of supplying the video signals is changed on a column-by-column basis. Specifically, sampling processing of the input signals to the column-driving circuits may be controlled, or an order of supplying video signals is changed on a column-by-column basis by means of a circuit (a correction circuit).

### First Embodiment

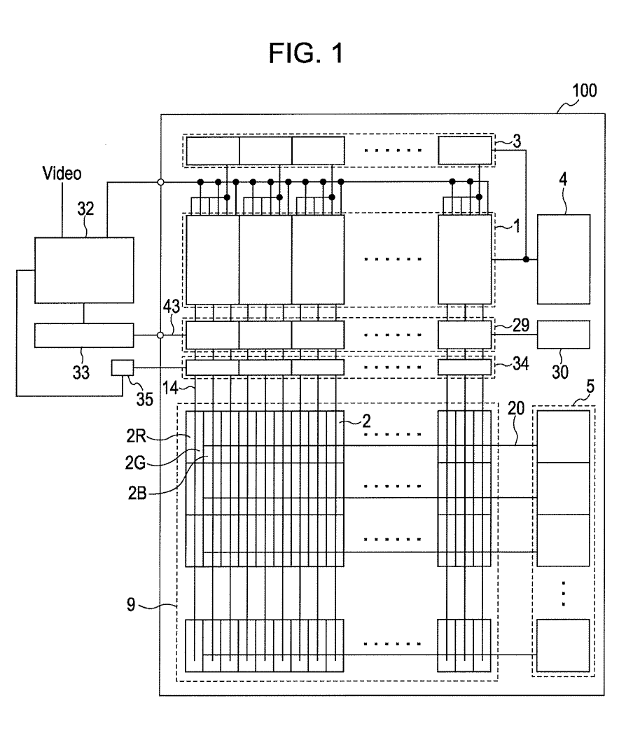

FIG. 1 is a schematic view illustrating a configuration of a display apparatus according to a first embodiment.

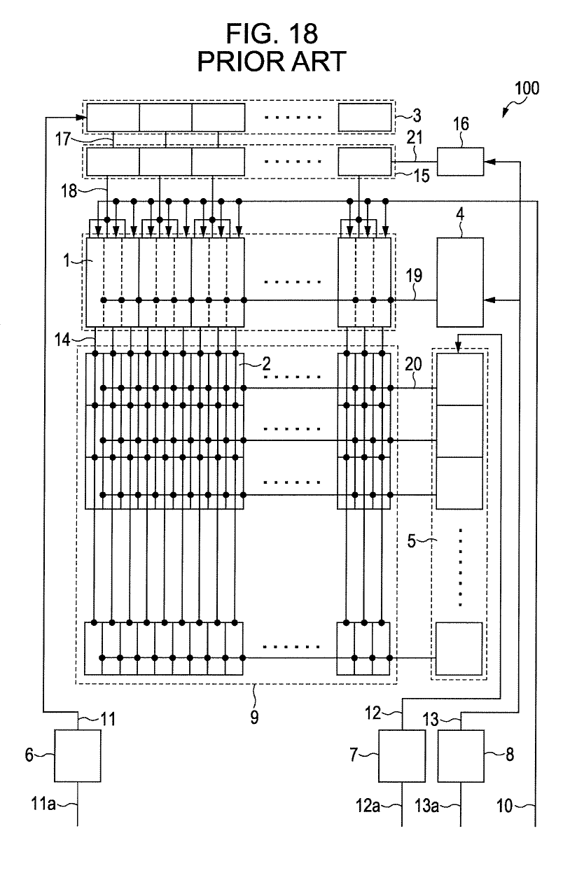

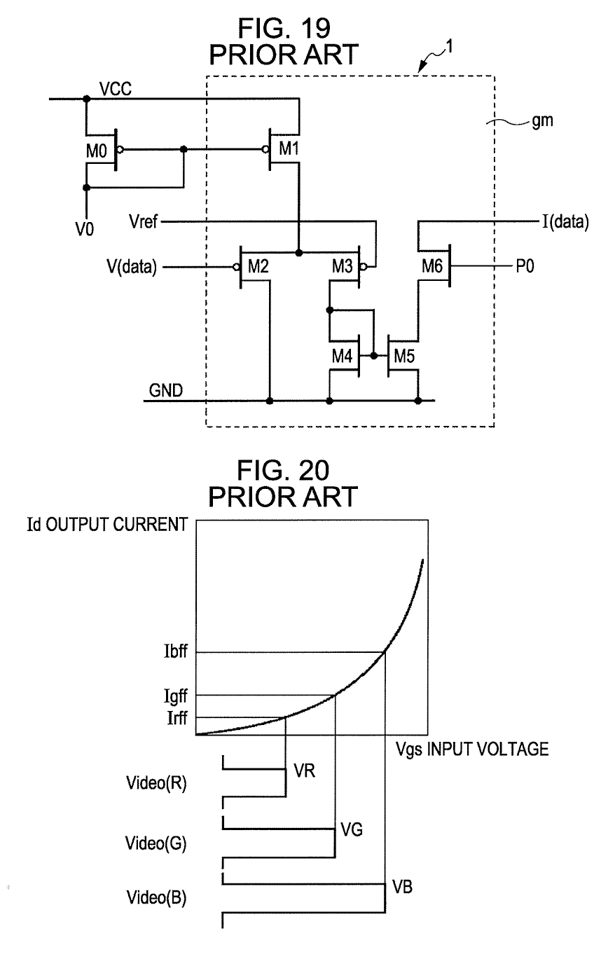

Note that the same components as those of the configuration of the related art shown in FIG. 18 denote the same reference numerals as those in FIG. 18. The input circuits 6, 7, and 8 shown in FIG. 18 are omitted.

The display apparatus shown in FIG. 1 includes a display panel 100. The display panel 100 has a common substrate. A plurality of EL devices and pixel circuits 2 including TFTs which control currents supplied to the EL devices are stacked on the common substrate. A pixel includes three RGB color components, that is, color pixels 2R, 2G, and 2B. The color pixels correspond to the pixel circuits 2. The color pixels are arranged in a matrix of 3N columns×M rows to constitute a color display unit 9. The color display unit 9 and peripheral circuits are arranged on the common substrate. The peripheral circuits include column-shift registers 3, row-shift registers 5, and gate circuits 4. In this embodiment, a total-current output circuit 29 and a selection circuit 34 are arranged between the column-driving circuits 1 and the pixel circuits 2. The total-current output circuit 29 detects and outputs current signals output from the corresponding column-driving circuits 1 as total currents. The total-current output circuit 29 has a control-signal input terminal connected to a gate circuit 30. The total-current output circuit 29 also has a control-signal output terminal connected to a total-current detection circuit 33. The total-current detection circuit 33 has an output terminal connected to a correction circuit 32 to which a total current detected by the total-current detection circuit 33 is supplied. Video signals Video are supplied to the column-driving circuits 1 through the correction circuit 32.

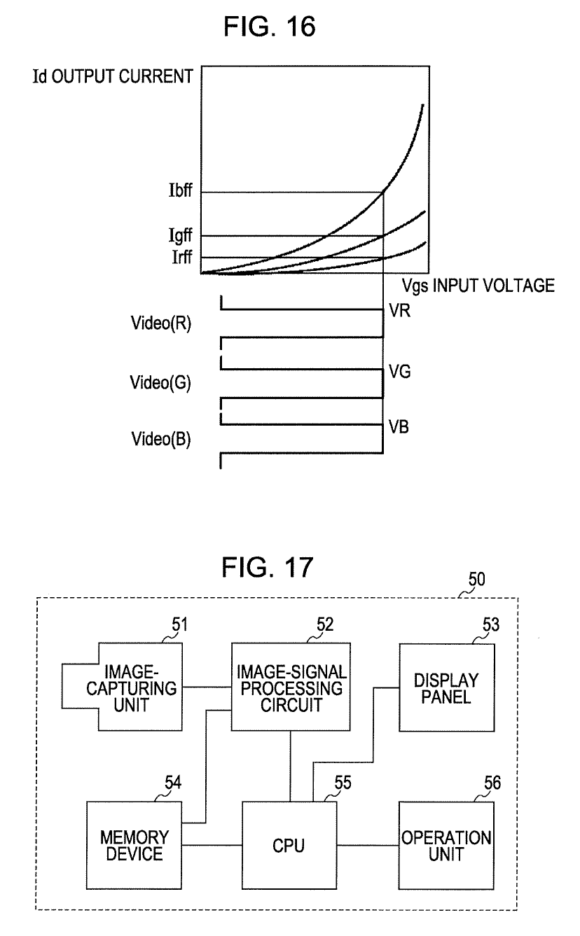

The circuit configuration disclosed in U.S. Pat. No. 7,126,565 may be applied to the circuits other than the selection circuit 34 and a control circuit 35, that is, the column-driving circuits 1, the pixel circuits 2, the total-current output circuit 29, and the correction circuit 32. Note that voltage-current conversion gains are set to the column-driving circuits in accordance with color data signals output from the column-driving circuits. Here, as shown in FIG. 16, a voltage-current conversion gain GainB of a column-driving circuit which outputs a blue data signal is set larger than each of a voltage-current conversion gain GainR of a column-driving circuit which outputs a red data signal and a voltage-current conversion gain GainG of a column-driving circuit which outputs a green data signal. Furthermore, the voltage-current conversion gain GainG of a column-driving circuit which outputs a green data signal is set larger than the voltage-current conversion gain GainR of a column-driving circuit which outputs a red data signal.

Assuming that β represents a gain of a voltage-current conversion transistor, Id represents a drain current, Vgs represents a voltage between a gate and a source, and Vth represents a threshold value of the transistor, Id=β(Vgs−Vth)² is obtained.

Comparing FIG. 16 with FIG. 20, in the display apparatus according to this embodiment, the voltage amplitudes of input video signals Video(R), Video(G), and Video(B) which give the same luminance are constant as shown by VR, VG, and VB for the corresponding color components R, G, and B. In other words, operation areas based on Vgs-Id characteristics of the voltage-current conversion transistors in the column-driving circuits are the same among R, G, and B pixels. The operation areas are not necessarily completely the same among the R, G, and B pixels and may be shifted in an error range or in a range corresponding to one gradation level.

A desired gain of the voltage-current conversion transistor can be obtained by changing a division ratio of capacitance connected to the voltage-current conversion transistor or the gate thereof.

### Current Detection Circuit

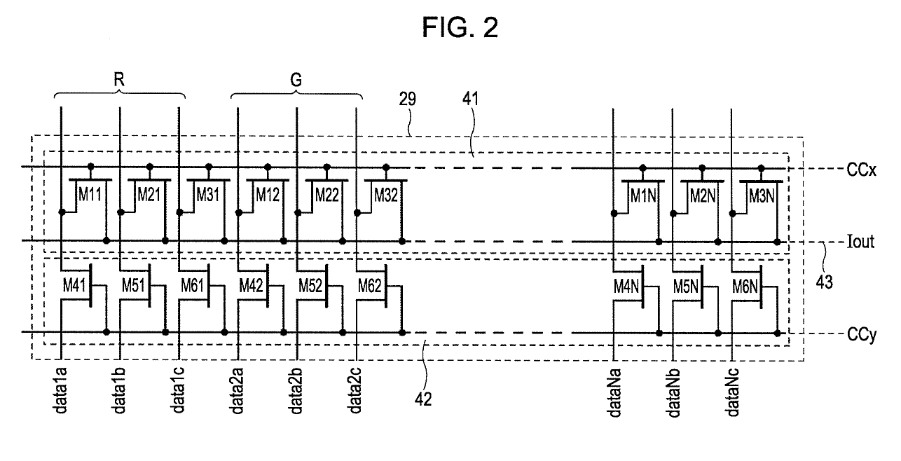

FIG. 2 illustrates an example of a circuit configuration illustrating the total-current output circuit 29 which is used as a current detection circuit and detects currents output from the column-driving circuits employed in the invention.

In FIG. 2, output currents of the column-driving circuits 1 are commonly connected to a current signal output line 43. A switch section 41 controls connection/disconnection between the column-driving circuits 1 and the current signal output line 43. A disconnection section 42 is a switch section which controls connection/disconnection between the column-driving circuits 1 and the pixels. In addition, data1a to dataNc denote data lines, M11 to M3N and M41 to M6N denote TFTs serving as switches, Iout denotes a total current, and CCx and CCy denote control signals used for detecting total currents.

When a total current is output from the total-current output circuit 29 and a video signal is to be corrected, a correction period is provided before a normal operation period. In the correction period, in the total-current output circuit 29, the switches M11 to M3N in the switch section 41 are turned on by the control signals CCx and the switches M41 to M6N are turned off by the control signals CCy. Accordingly, the current signals output from the column-driving circuits 1 are not supplied to the pixel circuits 2 but are output through the current signal output line 43.

Predetermined high-level voltages used for detecting output currents are input to the column-driving circuits 1 corresponding to the switches M11, M21, and M31 corresponding to the three columns of R pixels, whereas lowest-level voltages, for example, are input to the other column-driving circuits corresponding to the other columns. By this, a detection current signal in which the currents output from the column-driving circuits corresponding to the switches M11, M21, and M31 are added to one another is obtained. The detection current signal includes background currents obtained on the basis of the lowest-level voltages input to the other column-driving circuits corresponding to the other columns. The detection current signal is compared with reference data so that a correction coefficient k1 for a block of column-driving circuits corresponding to the switches M11, M21, and M31 is calculated.

Similarly, predetermined high-level voltages used for detecting output currents are input to the column-driving circuits corresponding to the switches M12, M22, and M32 corresponding to the three columns of G components, whereas lowest-level voltages, for example, are input to the other column-driving circuits corresponding to the other columns. By this, a detection current signal in which the currents output from the column-driving circuits corresponding to the switches M12, M22, and M32 are added to one another is obtained. The obtained detection current signal is compared with reference data so that a correction coefficient k2 for a block of column-driving circuits corresponding to the switches M12, M22, and M32 is calculated.

Similarly, predetermined high-level voltages used for detecting output currents are input to the column-driving circuits corresponding to the switches M13, M23, and M33 (not shown) corresponding to the three columns of B components, whereas lowest-level voltages, for example, are input to the other column-driving circuits corresponding to the other columns. By this, a detection current signal in which the currents output from the column-driving circuits corresponding to the switches M13, M23, and M33 (not shown) are added to one another is obtained. The obtained detection current signal is compared with reference data so that a correction coefficient k3 for a block of column-driving circuits corresponding to the switches M13, M23, and M33 (not shown) is calculated.

This operation is performed on blocks of column-driving circuits on a block-by-block basis by sequentially changing a block of column-driving circuits to be subjected to this operation to obtain correction coefficients k1, k2, k3, to kN. In this operation, detection signals are obtained as a value obtained by adding currents output from the predetermined number of column-driving circuits (here, three column-driving circuits). Accordingly, time for detecting the output currents is shortened to one third and detection signals having a desired S/N ratio can be obtained.

In addition, since calculation time required for correction in the correction circuit 32 is also shortened to one third, high-speed processing of video signals is achieved.

As a column-driving circuit, the circuit disclosed in U.S. Pat. No. 7,126,565, FIG. 1 may be employed. In this circuit, when output currents are detected and corrected, predetermined high-level voltages used for detection are input to voltage-current conversion circuits grouped as pairs of voltage-current conversion circuits, and voltage-current conversion circuits in each of the pairs of voltage-current conversion circuits are added to each other, whereby currents output from the pairs of voltage-current conversion circuits are simultaneously obtained. In this embodiment of the invention, detection signals may be simultaneously obtained from three pairs of voltage-current conversion circuits, that is, six voltage-current conversion circuits.

In FIG. 2, the N-channel transistors are used as the switches. However, P-channel transistors may be used.

### Correction Circuit

The correction circuit 32 according to this embodiment calculates reference data and each of the current signals obtained from the blocks of three column-driving circuits, the three column-driving circuits in each of the blocks for the same colors, that is, R, G, and B color components to thereby obtain each of the correction coefficients k1 to kN and store the correction coefficients k1 to kN. Three input video signals Video for R, G, and B color components are corrected using the correction coefficients k1 to kN, each of which is commonly used for corresponding signals for the same colors, stored in a line memory of the correction circuit 32.

The video signals corrected as described above are sequentially input to the column-driving circuits 1. For example, an input video signal for one pixel of the first column for the R color component is corrected by the correction coefficient k1 and is supplied to a column-driving circuit 1 in the first column. Similarly, an input video signal for one pixel of the second column for the R color component is corrected by the correction coefficient k1 and is supplied to a column-driving circuit 1 in the second column. Furthermore, an input video signal for one pixel of the third column for the R color component is corrected by the correction coefficient k1 and is supplied to a column-driving circuit 1 in the third column.

Then, an input video signal for one pixel of the first column for the G color component is corrected by the correction coefficient k2 and is supplied to a column-driving circuit 1 in the fourth column. Similarly, an input video signal for one pixel of the second column for the G color component is corrected by the correction coefficient k2 and is supplied to a column-driving circuit 1 in the fifth column. Furthermore, an input video signal for one pixel of the third column for the G color component is corrected by the correction coefficient k2 and is supplied to a column-driving circuit 1 in the sixth column.

Then, an input video signal for one pixel of the first column for the B color component is corrected by the correction coefficient k3 and is supplied to a column-driving circuit 1 in the seventh column. Similarly, an input video signal for one pixel of the second column for the B color component is corrected by the correction coefficient k3 and is supplied to a column-driving circuit 1 in the eighth column. Furthermore, an input video signal for one pixel of the third column for the B color component is corrected by the correction coefficient k3 and is supplied to a column-driving circuit 1 in the ninth column. The same operations are repeated for all column-driving circuits.

Since the video signals are supplied to each of the blocks of the adjacent three column-driving circuits 1 grouped by colors after being corrected by the corresponding correction coefficients obtained from the corresponding total currents, the correction of the variation in each of the blocks of three column-driving circuits, that is, the correction of the variation between EL devices in adjacent columns receiving different currents is not sufficiently assured. To address this drawback, the selection circuit 34, which will be described later, may be used in this embodiment.

In this embodiment described above, input video signals for color pixels are supplied in serial order, such as an order of RRRGGGBBB, from the correction circuit 32. However, in a case where input video signals for color pixels are supplied in serial order, such as an order of RGBRGBRGB, from the correction circuit 32, a connection configuration of column-shift registers 3 and the column-driving circuits 1 may be changed.

### Pixel Circuits

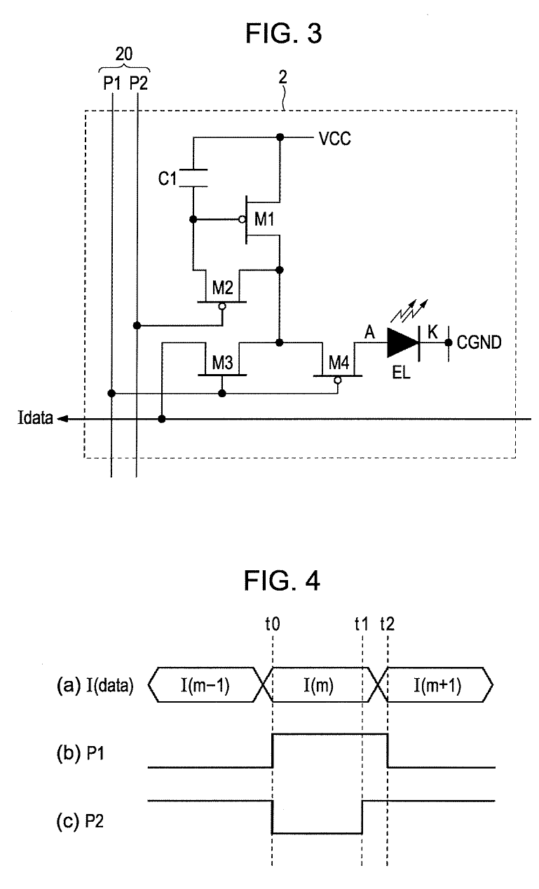

FIG. 3 illustrates a configuration of each of the pixel circuits 2 including an EL device according to this embodiment.

In FIG. 3, P1 and P2 are scanning signal lines to which current data signals Idata are input as data signals. An anode of the EL device is connected to the drain of a TFT M4. A cathode of the EL device is connected to the ground CGND. Note that TFTs M1, M2, and M4 are P-channel TFTs whereas a TFT M3 is an N-channel TFT.

FIG. 4 is a timing chart illustrating a driving method of the pixel circuits 2. In FIG. 4, I(m−1), I(m), and I(m+1) denote current data signals Idata. The current data signals I(m−1), I(m), and I(m+1) are supplied to pixel circuits 2 of (m−1)th column (a column immediately before a column of interest), pixel circuits 2 of m-th column (the column of interest), and pixel circuits 2 of (m+1)th column (a column immediately after the column of interest), respectively.

In FIG. 4, before a time point t0, low-level signals are supplied to the scanning signal line P1 and high-level signals are supplied to the scanning signal line P2 in the pixel circuits in the column of interest. The transistors M2 and M3 are turned off, whereas the transistor M4 is turned on in each of the pixel circuits 2. In this case, the current data signals I(m−1), which are to be supplied to the pixel circuits 2 in the column immediately before the column of interest, are not supplied to the pixel circuits 2 in the column of interest.

At the time point t0, high-level signals are supplied to the scanning signal line P1 and low-level signals are supplied to the scanning signal line P2. The transistors M2 and M3 are turned on, whereas the transistor M4 is turned off in each of the pixel circuits 2. In this case, the current data signals I(m), which are to be supplied to the pixel circuits 2 in the column of interest, are supplied to the pixel circuits 2 in the column of interest. In this case, since the transistor M4 is not in a conductive state, currents are not supplied to the EL devices. In each of the pixel circuits 2, the input current data signal Idata causes generation of voltages across a capacitor C1 arranged between the gate of the transistor M1 and a power supply potential VCC, in accordance with a current-driving capability of the transistor M1. Accordingly, a current-voltage conversion is performed in each of the pixel circuits 2 at first.

At a time point t1, high-level signals are supplied to the scanning signal line P2 and the transistor M2 is turned off. At a time point t2, low-level signals are supplied to the scanning signal line P1 and the transistor M3 is turned off whereas the transistor M4 is turned on in each of the pixel circuits 2. In this case, since the transistor M4 is in a conductive state, currents obtained in accordance with a current-driving capability of the transistor M1 are supplied to the EL devices using the voltage generated in the capacitor C1. Accordingly, a voltage-current conversion is performed and therefore the EL devices emit light having luminance in accordance with the supplied currents.

In this embodiment, the configuration as illustrated in FIG. 3 is taken as an example of a pixel circuit. However, the configuration of the pixel circuit is not limited to this.

### Column Driving Circuit

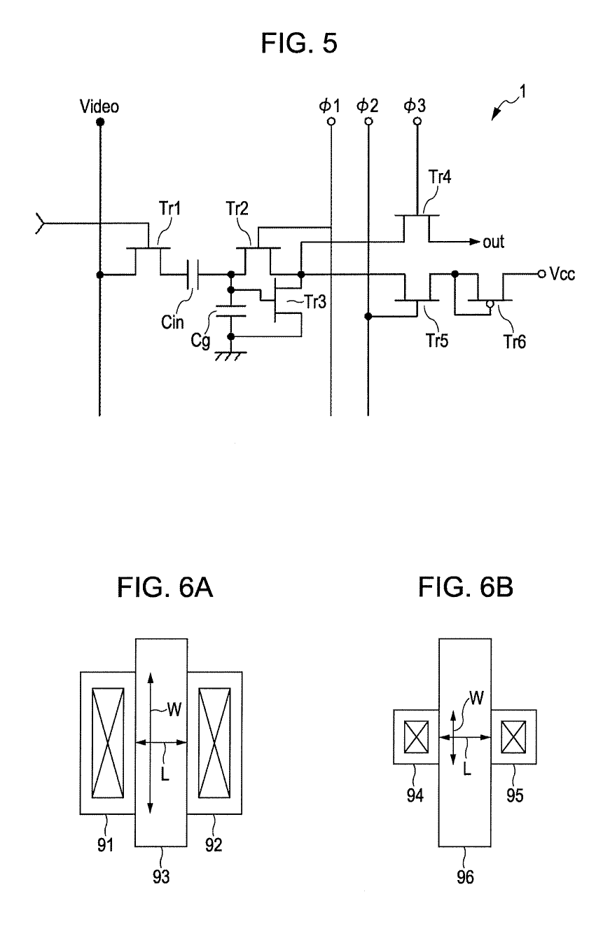

FIG. 5 is a circuit diagram illustrating a voltage-current conversion circuit employed in each of the column-driving circuits according to the invention, and description will be made for one column-driving circuit 1 hereinafter for simplicity.

The column-driving circuit 1 includes at least first to sixth transistors Tr1 to Tr6 and capacitors Cin and Cg.

The first transistor Tr1 serving as a first switch has a first terminal which is connected to a video line Video to which a video signal is input. The first transistor Tr1 also has a second terminal which is connected to a first terminal of the first capacitor Cin. The first capacitor Cin has a second terminal which is connected to a gate electrode of the third transistor Tr3 which is used for voltage-current conversion. The second transistor Tr2 has a first terminal which is connected to a gate electrode of the transistor Tr3 and a second terminal which is connected to a second main electrode of the transistor Tr3. The transistor Tr3 has a first main electrode which is connected to a ground terminal serving as a reference voltage source. The second main electrode of the transistor Tr3 is connected between the first terminal of the transistor Tr4 and a first terminal of the transistor Tr5. The transistor Tr5 has a second terminal which is connected between a first main electrode and a gate electrode of the transistor Tr6. The transistor Tr6 has a second main electrode which is connected to a second reference voltage source (VCC).

First, the video line Video is kept in a blanking level. Here, the transistor Tr1 is turned on, the transistor Tr2 is turned off, the transistor Tr5 is turned on, and the transistor Tr4 is turned off. In this state, the transistor Tr2 is turned on, and subsequently, the transistor Tr5 is turned off. Thus, a charging operation of the gate of the transistor Tr3 is stopped and a voltage of the gate of the transistor Tr3 approximates to a threshold voltage Vth thereof.

Then, the transistor Tr1 is turned off, and subsequently, the transistor Tr2 is turned off. Here, a self-discharging operation of the transistor Tr3 is terminated.

Then, the transistor Tr5 is turned on. Here, since the gate voltage of the transistor Tr3 is the same as or approximately the same as the threshold voltage Vth thereof, a drain current of the transistor Tr3 does not flow.

Here, when the transistor Tr1 is turned on, a video signal is supplied. The gate voltage is increased by a value obtained by the difference between a level of the video signal and the blanking level, and a voltage of the video signal is held in the gate capacitor Cg of the transistor Tr3. Accordingly, the variation in the threshold voltage Vth of the transistor Tr3 is compensated for.

Here, when the transistor Tr5 is turned off and the transistor Tr4 is subsequently turned on, the voltage held in the gate capacitor Cg, that is, a current obtained in accordance with the video-signal voltage, is supplied to an output terminal OUT. The current corresponds to a data-signal current which should be used in each of the pixel circuits 2 subjected to current programming.

FIGS. 6A and 6B are schematic views illustrating configurations of voltage-current conversion transistors employed in voltage-current conversion circuits according to the invention.

FIG. 6A shows a transistor having a high driving capability and FIG. 6B shows a transistor having a low driving capability.

Reference numerals 91, 92, 94, and 95 denote main electrode areas (source or drain areas) and 93 and 96 denote gate electrodes. A reference character W denotes a channel width and a reference character L denotes a channel length of each of the transistors. Here, the larger W/L ratio, the higher the driving capability of a transistor, that is, a voltage-current conversion gain herein. Accordingly, the transistor shown in FIG. 6A is employed for a column-driving circuit used for an electro-optical device having a comparatively low luminance efficiency, whereas the transistor shown in FIG. 6B is employed for a column-driving circuit used for an electro-optical device having a comparatively high luminance efficiency.

### Selection Circuit

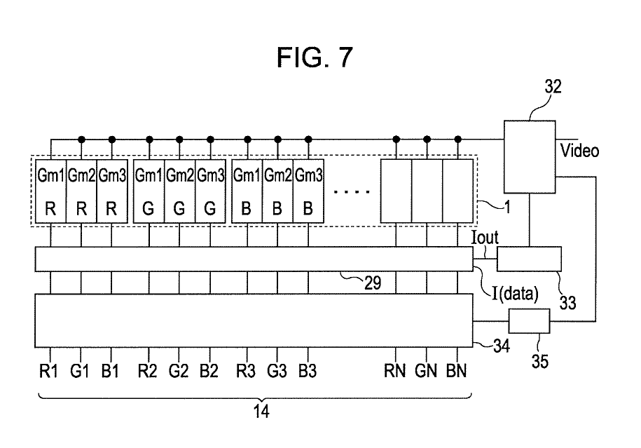

The selection circuit 34 of this embodiment will now be described with reference to FIG. 7.

FIG. 7 shows a configuration including the column-driving circuits 1, the total-current output circuit 29, the total-current detection circuit 33, the selection circuit 34, the control circuit 35, and the correction circuit 32. The column-shift register 3 is omitted for ease of explanation.

Video signals corrected by the correction coefficients are supplied to the selection circuit 34 through the column-driving circuits 1, and the total-current output circuit 29 and then the data lines 14. Note that the column-driving circuits 1 are divided into blocks so that three successive column-driving circuits 1 are included in each of the blocks and the same color video signals are supplied to the column-driving circuits 1 in the same block. Accordingly, the characteristics of the voltage-current conversion transistors in the three successive column-driving circuits 1 approximate one another. The column-driving circuits 1 are used to supply data-signal currents to the successive columns to which the signals for the same color are to be supplied.

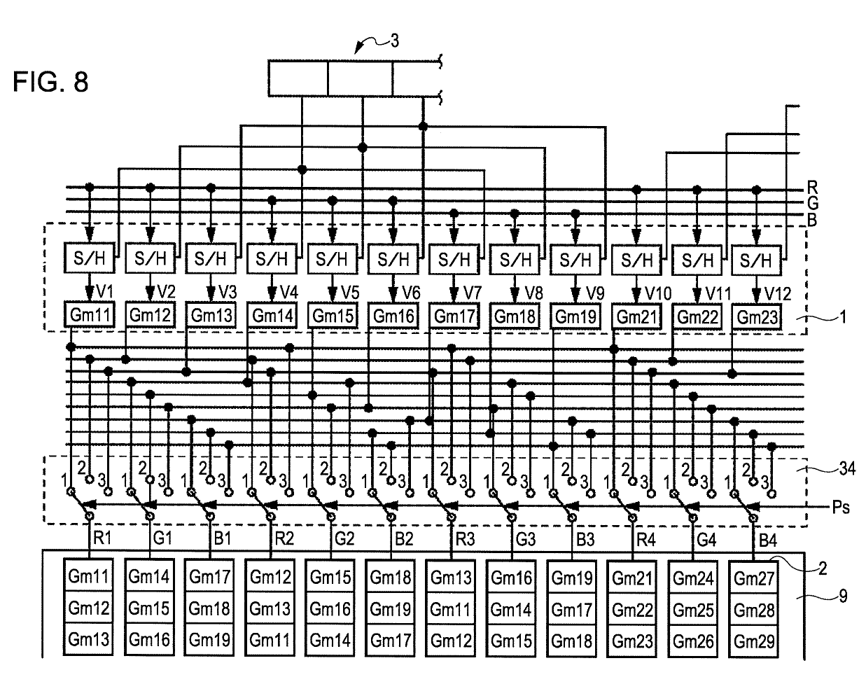

FIG. 8 is a schematic diagram illustrating the selection circuit 34 and the vicinity thereof according to the invention. In FIG. 8, for simplicity, the total-current output circuit 29, the total-current detection circuit 33, the correction circuit 32, and the control circuit 35 shown in FIG. 7 are omitted and part of the color display unit 9 is additionally shown.

Sample/hold circuits S/H which are disposed in the column-driving circuits 1 are additionally shown in FIG. 8.

Voltage-current conversion circuits Gm convert video-signal voltages into data-signal currents. Specifically, R signals are input to voltage-current conversion circuits Gm11, Gm12, Gm13, Gm21, Gm22, and Gm23, G signals are input to the voltage-current conversion circuits Gm14, Gm15, and Gm16, and B signals are input to the voltage-current conversion circuits Gm17, Gm18, and Gm19. The driving capabilities of the voltage-current conversion transistors in the voltage-current conversion circuits Gm are changed for each color since luminances with respect to supplied currents, that is, the luminance efficiencies, are different among colors. To change each of the driving capabilities of the transistors, a W/L (channel width/channel length) ratio for the transistor is changed. For example, W/L ratios of the voltage-current conversion transistors in the voltage-current conversion circuits Gm17, Gm18, and Gm19, to which B signals are supplied, are larger than W/L ratios of voltage-current conversion transistors in the other voltage-current conversion circuits Gm.

In this way, since the driving capabilities of the voltage-current conversion transistors in the voltage-current conversion circuits Gm for the B signals which have the low luminance efficiencies are set higher, the voltage amplitudes for video signals corresponding to the R signals and the G signals do not have to be set lower than those corresponding to the B signals. Therefore, in the luminance level which varies from the lower level to the higher level, the Vgs-Id characteristics of the voltage-current conversion transistors in the voltage-current conversion circuits Gm for the R, G, and B color components are changed in the same current characteristic area. Accordingly, differences between gamma characteristics caused by differences between areas in which the Vgs-Id characteristics are changed do not have to be compensated for each of the R, G, and B color components.

Note that the invention is not limited to the technique in which only the voltage-current conversion transistors in the voltage-current conversion circuits Gm for B signals have W/L ratios larger than those of the voltage-current conversion transistors in the voltage-current conversion circuits Gm for R signals and the voltage-current conversion transistors in the voltage-current conversion circuits Gm for G signals. As described above, the W/L ratios of the voltage-current conversion transistors in the voltage-current conversion circuits Gm may be changed for individual colors.

Operation of the selection circuit 34 shown in FIG. 8 will be described. Signals are divided into blocks and each of the groups includes an R pixel, a G pixel, and a B pixel to be displayed which are successively arranged in each of a plurality of rows. The signals are sequentially supplied to input lines dedicatedly used for each color.

For example, a video signal for an R pixel in the first column is supplied to and held in a sample/hold circuit S/H corresponding to the voltage-current conversion circuit Gm11, a video signal for a G pixel in the first column is supplied to and held in a sample/hold circuit S/H corresponding to the voltage-current conversion circuit Gm14, and a video signal for a B pixel in the first column is supplied to and held in a sample/hold circuit S/H corresponding to the voltage-current conversion circuit Gm17. Subsequently, a video signal for an R pixel in the second column is supplied to a sample/hold circuit S/H corresponding to the voltage-current conversion circuit Gm12, a video signal for a G pixel in the second column is supplied to a sample/hold circuit S/H corresponding to the voltage-current conversion circuit Gm15, and a video signal for a B pixel in the second column is supplied to a sample/hold circuit S/H corresponding to the voltage-current conversion circuit Gm18. Subsequently, a video signal for an R pixel in the third column is supplied to a sample/hold circuit S/H corresponding to the voltage-current conversion circuit Gm13, a video signal for a G pixel in the third column is supplied to a sample/hold circuit S/H corresponding to the voltage-current conversion circuit Gm16, and a video signal for a B pixel in the third column is supplied to a sample/hold circuit S/H corresponding to the voltage-current conversion circuit Gm19.

Similarly, video signals in the fourth column onward are sequentially supplied to and held in the corresponding sample/hold circuits S/H.

After the video signals for one row are supplied to and held for individual colors in the corresponding sample/hold circuits S/H, the video signals are simultaneously supplied to the corresponding voltage-current conversion circuits Gm11 to Gm23. The video signals are converted into currents, that is, data-signal currents, in the voltage-current conversion circuits Gm11 to Gm23, and the data-signal currents are supplied to the data lines of the color display unit 9 through the total-current output circuit 29.

Video signals V1, V2, and V3 denote R-pixel video signals which are supplied to the voltage-current conversion circuits in the column-driving circuits 1. Similarly, video signals V4, V5, and V6 denote G-pixel video signals, and video signals V7, V8, and V9 denote B-pixel video signals.

The data-signal currents which were converted from voltages to currents in the column-driving circuits 1 are output through data lines specified on the basis of a state selected from connection points 1, 2, and 3 in accordance with switching control signals Ps supplied from the control circuit 35.

For example, the connection points are switched for each horizontal scanning period (1H) in accordance with the switching control signals Ps and the data-signal currents are sequentially programmed for the corresponding pixel circuits provided for each column.

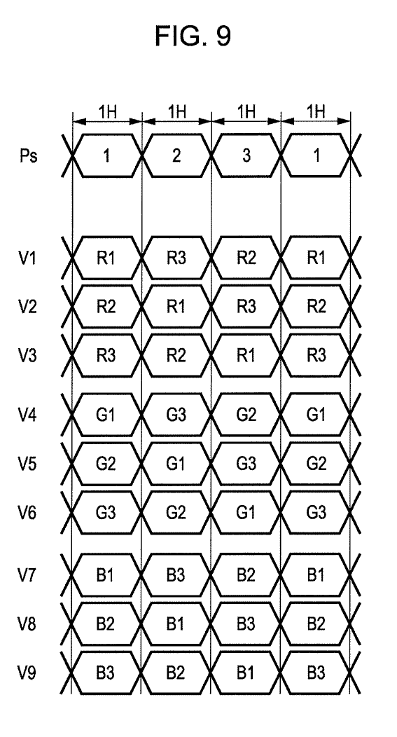

FIG. 9 is a timing chart in the case of the selection circuit 34 being activated. Here, only the R-pixel video signals are taken as an example. In accordance with a control signal Ps, when the connection points 1 are selected in accordance with a control signal Ps in a period 1H, an output from a column-driving circuit 1 obtained on the basis of the R-pixel video signal V1 is supplied to a data line R1, an output from a column-driving circuit 1 obtained on the basis of the R-pixel video signal V2 is supplied to a data line R2, and an output from a column-driving circuit 1 obtained on the basis of the R-pixel video signal V3 is supplied to a data line R3.

When the connection points 2 are selected in accordance with a control signal Ps in a period 1H, an output from a column-driving circuit 1 obtained on the basis of the R-pixel video signal V1 is supplied to a data line R3, an output from a column-driving circuit 1 obtained on the basis of the R-pixel video signal V2 is supplied to a data line R1, and an output from a column-driving circuit 1 obtained on the basis of the R-pixel video signal V3 is supplied to a data line R2.

Furthermore, when the connection points 3 are selected in accordance with a control signal Ps in a period 1H, an output from a column-driving circuit 1 obtained on the basis of the R-pixel video signal V1 is supplied to a data line R2, an output from a column-driving circuit 1 obtained on the basis of the R-pixel video signal V2 is supplied to a data line R3, and an output from a column-driving circuit 1 obtained on the basis of the R-pixel video signal V3 is supplied to a data line R1. Then, the connection points 1 are again selected in accordance with a control signal Ps. Similarly, connection points are changed in accordance with a control signal Ps for each 1H period from the points 1, the points 2, to the points 3, and again started from the points 1 onward and the operation described above is repeated whereby connection points of the selection circuit 34 with the total-current output circuit 29 are changed.

Since the operations described above are sequentially performed, variations in the characteristics among successive three voltage-current conversion circuits used for the same color, which lead to an adverse effect on luminance, are distributed over seven columns of spaces and nonuniform display of fixed patterns can be suppressed.

Although the variations in the output currents among the three successive voltage-current conversion circuits used for the same color, which constitute one block, are spatially distributed using the selection circuit 34, variations in output current among a plurality of blocks cannot be considerably suppressed.

In this case, using the configurations shown in FIGS. 2 and 7, currents output from three voltage-current conversion circuits Gm are detected for each block and the detected currents are corrected. Accordingly, variations in output current among blocks can be suppressed.

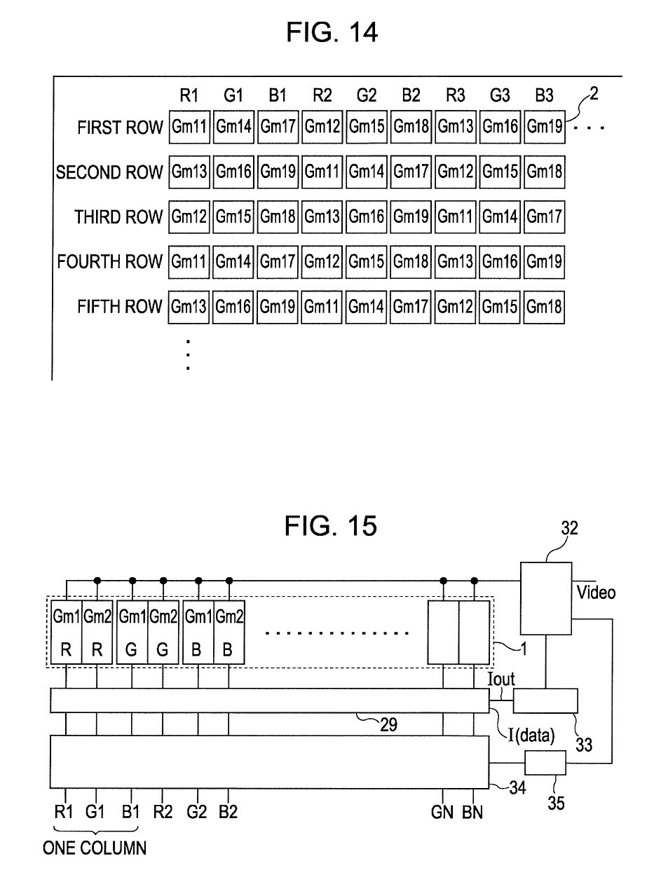

Specifically, the total-current output circuit 29 shown in FIG. 5 is disposed between the column-driving circuits 1 and the selection circuit 34. Video signals for same-color pixels are input to three column-driving circuits 1 (for example, the voltage-current conversion circuits Gm11, Gm12, and Gm13) and output therefrom as currents. The output currents from the three column-driving circuits 1 are detected and calculated to obtain a total current Iout in the total-current output circuit 29 and the total current Iout is supplied to the total-current detection circuit 33. The total-current detection circuit 33 outputs the total current Iout to the correction circuit 32. The correction circuit 32 compares a reference signal current provided for each color with the total current Iout generated by the currents output from the three column-driving circuits 1 used for the corresponding color pixels. For example, in FIG. 14, the correction circuit 32 compares a total current Iout for R-pixel signals with a reference signal current Irff to obtain a current coefficient, compares a total current Iout for G-pixel signals with a reference signal current Igff to obtain a current coefficient, and compares a total current Iout for B-pixel signals with a reference signal current Ibff to obtain a current coefficient. Then, the correction circuit 32 stores the correction coefficients obtained from the corresponding blocks having three column-driving circuits 1 in a line memory thereof including an SRAM. The video signals are corrected using the correction coefficients stored in the correction circuit 32 and the corrected video signals are input to the column-driving circuits 1. The data signals output from the column-driving circuits 1 are supplied to the pixel circuits 2 through the data lines. Alternatively, the correction circuit 32 performs calculation processing using the currents output from the three column-driving circuits 1 which receive the same color signals and a reference signal current commonly used for the RGB color pixels to obtain a correction coefficient for each of the blocks including three column-driving circuits 1, and stores the obtained correction coefficient. The video signals are corrected using the correction coefficients stored in the correction circuit 32 and contrast ratios for the individual RGB color pixels and are input to the corresponding column-driving circuits 1. The video signals are converted into currents, and the currents are output from the column-driving circuits 1 to the pixel circuits 2 through the data lines. Accordingly, variations in the current output from the column-driving circuits 1, to which the video signals for the same-color pixels are supplied, among the blocks of the column-driving circuits 1 is suppressed.

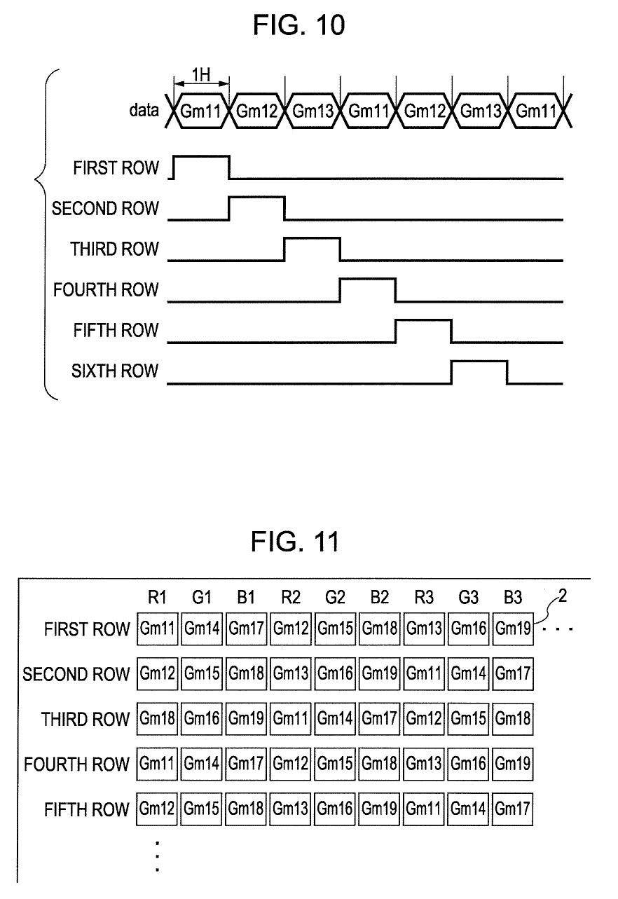

FIGS. 10 and 11 illustrate examples of operations according to this embodiment.

FIG. 10 shows a programming timing of a plurality of R pixels connected to the data line R1. Each of the rows is selected in a non-interlace method for each horizontal scanning period, and data-signal currents to be supplied to R-pixel circuits in the selected row are programmed.

Specifically, in the first 1H period, pixel circuits in the first row are selected, and video signals subjected to voltage-current conversion in the voltage-current conversion circuits Gm11 are programmed for the pixel circuits in the first row. In the second 1H period, pixel circuits in the second column are selected, and video signals subjected to voltage-current conversion in the voltage-current conversion circuits Gm12 are programmed for the pixel circuits in the second row. In the third 1H period, pixel circuits in the third column are selected, and video signals subjected to voltage-current conversion in the voltage-current conversion circuits Gm13 are programmed for the pixel circuits in the third row. In the fourth 1H period, pixel circuits in the fourth column are selected, and video signals subjected to voltage-current conversion in the voltage-current conversion circuits Gm11 are programmed for the pixel circuits in the fourth row.

FIG. 11 illustrates the relationship between pixel circuits arranged in a matrix of 3 columns×5 rows, where 3 columns include R, G, and B pixels, and the voltage-current conversion circuits Gm which perform programming operations on the corresponding pixel circuits. Note that pixel circuits adjacent to each other are not programmed by the same voltage-current conversion circuit Gm. An order of programming operations is not limited to the order described above.

Use of the driving method described above can suppress the generation of nonuniform display of fixed patterns.

A panel including pixels having R, G, and B color pixels is described in this embodiment. Alternatively, a panel which includes pixels having n primary colors (n: integer) and which includes column-driving circuits in which driving capabilities thereof are set for each input primary color may have a configuration to be utilized similarly to this embodiment.

In this embodiment, for example, the voltage-current conversion circuits Gm corresponding to the same-color pixels take turns in performing current programming on the same pixel circuit for each field. Specifically, the voltage-current conversion circuits Gm11, Gm12, GM13, and GM11 onward may sequentially perform current programming on a pixel located in the first row of the R1 column for each field in that order.

### Second Embodiment

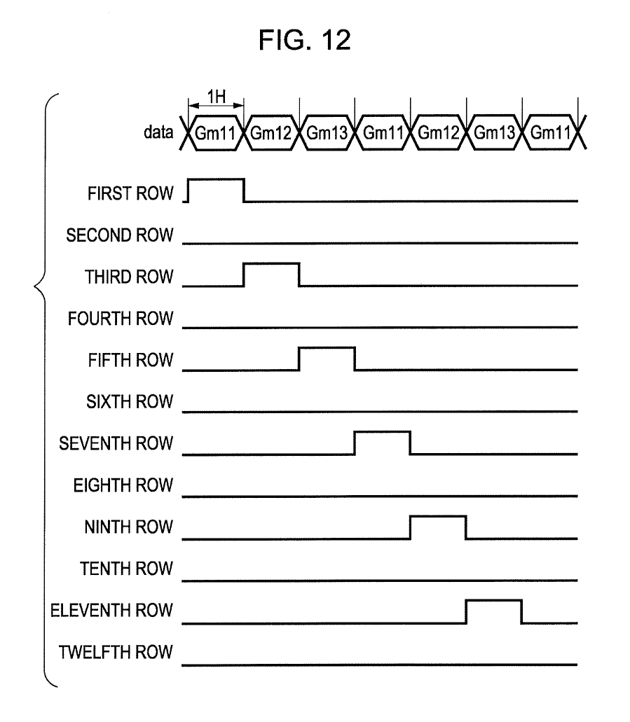

Referring to FIGS. 12 and 14, a second embodiment in which devices perform programming operations on pixel circuits by an interlace scanning method will be described. The basic circuit configuration of each of the devices is the same as the voltage-current conversion circuits Gm described in the first embodiment.

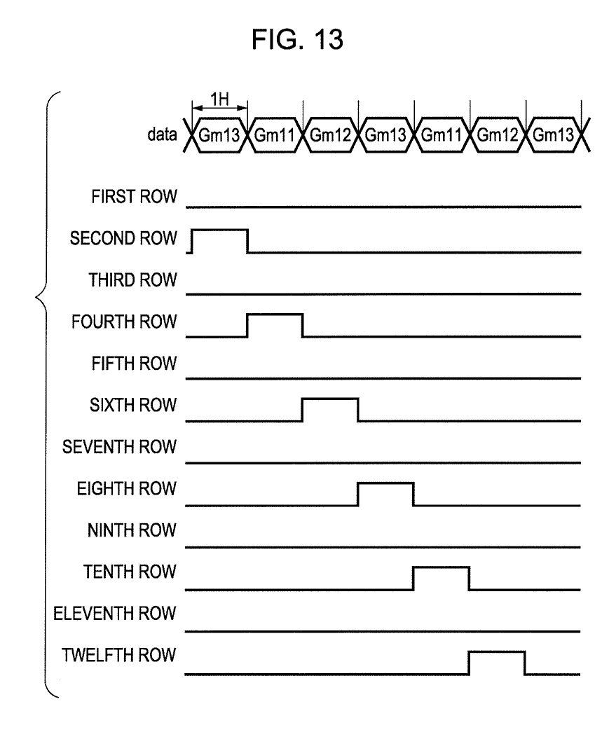

FIGS. 12 and 13 are timing charts illustrating programming operations performed on a plurality of R pixels connected to the data line R1. Odd-numbered rows are selected in ODD fields. As shown in FIG. 12, the first row is selected in the first 1H period, and data-signal currents converted in the voltage-current conversion circuit Gm11 are programmed for pixel circuits in the first row. The third row is selected in the second 1H period, and data-signal currents converted in the voltage-current conversion circuit Gm12 are programmed for pixel circuits in the third row. The fifth row is selected in the third 1H period, and data-signal currents converted in the voltage-current conversion circuit Gm13 are programmed for pixel circuits in the fifth row. The seventh row is selected in the fourth 1H period, and data-signal currents converted in the voltage-current conversion circuit Gm11 are again programmed for pixel circuits in the seventh row.

As described above, pixel circuits located in the (2N−1)th row (N: integer) are sequentially subjected to current programming for each 1H period in this field by the voltage-current conversion circuits Gm11, Gm12, Gm13, and Gm11 onward in that order.

Even-numbered rows are selected in an EVEN field. As shown in FIG. 13, the second row is selected in the first 1H period, and data-signal currents converted in the voltage-current conversion circuit Gm13 are programmed for pixel circuits in the second row. The fourth row is selected in the second 1H period, the sixth row is selected in the third 1H period, and the eighth row is selected in the fourth 1H period. As described above, pixel circuits located in the 2N-th row (N: integer) are sequentially subjected to current programming for each 1H period in this field by the voltage-current conversion circuits Gm13, Gm12, Gm11, and Gm13 onward in that order.

FIG. 14 illustrates the relationship between pixel circuits arranged in a matrix of 3 columns×5 rows, where 3 columns include R, G, and B pixels, and the voltage-current conversion circuits Gm which program the corresponding pixel circuits.

For example, in the EVEN fields, in a case where current programming is repeatedly performed by the voltage-current conversion circuits Gm11, Gm12, Gm13, and Gm11 onward in this order similarly to the ODD fields, data-signal currents supplied from the same voltage-current conversion circuit Gm are used for programming operations for pixel circuits in two successive rows. This leads to nonuniform display of fixed patterns. Accordingly, it is preferable that when current programming operations are performed in interlace scanning, a situation in which only one column-driving circuit is used in two fields in a frame scanning period is avoided, that is, different column-driving circuits are used to supply currents to the two fields in a frame scanning period.

A selection method for the selection circuit 34 may be set for each field to prevent pixel circuits in successive rows from being subjected to current programming by the same voltage-current conversion circuit Gm. An order of programming operations of the voltage-current conversion circuits Gm is not limited to the order described above. Voltage-current conversion circuits Gm corresponding to the same color may be successively used to perform current programming on a certain pixel for each frame scanning. Specifically, a pixel located in the first row of the R1 column is sequentially subjected to current programming performed by the voltage-current conversion circuits Gm11, Gm12, Gm13, and Gm11 onward in that order for frames.

### Third Embodiment

In the first and second embodiments, the R, G, and B pixel columns are taken as one column, and correction coefficients are stored in a plurality of memory devices corresponding to the number of a plurality of columns in one block, whereby correction operations are performed. However, the present invention is not limited to this. Correction coefficients may be stored in a plurality of memory devices which do not correspond to the number of columns in one block, whereby correction operations are performed.

For example, in a case where a plurality of column-driving circuits are divided into blocks, each of which includes S column-driving circuits (S: integer), and the blocks are successively arranged, that is, in a case where R signals are input to S column-driving circuits, G signals are input to S column-driving circuits, and B signals are input to S column-driving circuits, the S column-driving circuits are grouped as a color block. In each of the color blocks, column-driving circuits to which the same-color video signals are input are sequentially connected to corresponding S data lines with predetermined time intervals. Furthermore, three correction coefficients may be generated for each of the color blocks having S column-driving circuits to which the same-color video signals are input and the correction coefficients may be stored in memory devices.

Specifically, as shown in the configuration of the panel illustrated in FIG. 15, R, G, and B pixel columns are taken as one column and column-driving circuits corresponding to two pixel columns are grouped as one block. In this block, two column-driving circuits (Gm1 and Gm2) to which same-color signals are input are arranged so as to be adjacent to each other, and output destinations of the two column-driving circuits are changed every predetermined period of time. Accordingly, variations in the characteristics among voltage-current conversion transistors in the two column-driving circuits to which the same-color video signals are input in one block are distributed. Furthermore, video signals input to the two column-driving circuits are detected as a total current Iout and a correction coefficient for the corresponding block is stored in a memory device whereby a correction operation is performed.

The selection circuit configured to reduce the luminance variation and a correction circuit configured to correct signals by detecting currents may be independently operated.

The display apparatuses described in the above embodiments may be employed in various electronic apparatuses.

FIG. 17 is a block diagram illustrating a digital still camera system as an electronic apparatus to which the invention is applied. In FIG. 17, 50 denotes a digital still camera system, 51 denotes an image-capturing unit, 52 denotes an image-signal processing circuit, 53 denotes a display panel, 54 denotes a memory device, 55 denotes a CPU (Central Processing Unit), and 56 denotes an operation unit.

In FIG. 17, images captured by the image-capturing unit 51 or images stored in the memory device 54 are subjected to signal processing in the image-signal processing circuit 52 whereby the processed images can be seen in the display panel 53. The CPU 55 controls the image-capturing unit 51, the memory device 54, and the image-signal processing circuit 52 in response to inputs through the operation unit 56 whereby desired image capturing, desired recording, desired reproduction, and desired display of images are performed. In addition, the display panel 53 is used as a display unit for various electronic apparatuses.

In the display apparatus and the active matrix apparatus according to the embodiments of the invention, driving capabilities of the voltage-current conversion circuits in the column-driving circuits which supply desired currents to the RGB color components are different between at least two color components in three color components.

Examples of an information display apparatus according to the invention include a cellular phone, a portable personal computer, a digital still camera, or a video camera, and further include an apparatus which implements functions possessed by such apparatuses. The information display device has an information input unit. For example, an information input unit of a cellular phone includes an antenna. An information input unit of a PDF or a portable personal computer includes an interface unit used for connection to a network. An information input unit of a digital still camera or a movie camera includes an optical sensor unit, such as a CCD sensor or a CMOS sensor.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-097997 filed Mar. 31, 2006, which is hereby incorporated by reference herein in its entirety.

What is claimed is:

1. A display apparatus comprising:
a color display unit including pixels arranged in a matrix, the pixels including first pixels each emitting first light in accordance with a current, and second pixels each emitting second light, which color is different from the first light, in accordance with a current;
row selection lines provided for rows in the matrix of the pixels in the color display unit;
data lines provided for columns in the matrix of the pixels in the color display unit, pixels in each of the columns being used for displaying the same color; and
column-driving circuits configured to convert input video-signal voltages into data-signal currents and to output the data-signal currents to the data lines, the column-driving circuit being provided for corresponding data lines,
wherein an efficiency of luminance of each of the first pixels relative to a current is lower than that of each of the second pixels relative to a current, and
wherein voltage-current conversion gains of the column-driving circuits which supply data-signal currents to corresponding data lines used for the first pixels are set larger than those of the column-driving circuits which supply data-signal currents to corresponding data lines used for the second pixels.

2. The display apparatus according to claim 1, further comprising:
a correction circuit configured to detect outputs of the column-driving circuits and to correct, in accordance with results of the detection, video-signal voltages supplied to the column-driving circuits.

3. The display apparatus according to claim 1, further comprising:
selection circuits configured to provide connections between the data lines and the outputs of the corresponding column-driving circuits which supply the data-signal currents, and to periodically change the connection between a pair of a data line and a column-driving circuit by selecting a column-driving circuit for the connection from a plurality of the column-driving circuits in a certain block having the same voltage-current gains, the selection circuits being arranged between output sides of the column-driving circuits and the data lines.

4. The display apparatus according to claim 3, further comprising:
a correction circuit configured to detect outputs of the column-driving circuits and to correct, in accordance with results of the detection, video-signal voltages supplied to the column-driving circuits divided into blocks on a block-by-block basis.

5. The display apparatus according to claim 3,
wherein certain rows are selected by an interlace scanning method, and two pixels located in adjacent rows to which data-signal currents are supplied from a common data line receive outputs different from each other supplied from different column-driving circuits in different field periods because of the change of the selection circuit.

6. The display apparatus according to claim 1,
wherein the first pixels include light-emitting devices displaying blue, and the second pixels include light-emitting devices displaying red or green.

7. The display apparatus according to claim 1,
wherein the color display unit further includes third pixels each emitting light in accordance with a current and displays a third color different from the first and second colors,
wherein an efficiency of luminance of each of the first pixels relative to a current is lower than that of each of the third pixels relative to a current, and
wherein voltage-current conversion gains of the column-driving circuits which supply data-signal currents to corresponding data lines used for the first pixels are set larger than those of the column-driving circuits which supply data-signal currents to corresponding data lines used for the third pixels.
